(19) United States
(12) Patent Application Publication
(10) Pub. No.: US 2013/0003487 A1
(43) Pub. Date: Jan. 3, 2013

(54) Small Bottle Shaker

(76) Inventor: Nanci BALLARD, San Bernardino, CA (US)

(21) Appl. No.: 13/540,519

(22) Filed: Jul. 2, 2012

Related U.S. Application Data
(60) Provisional application No. 61/502,858, filed on Jun. 30, 2011.

(51) Int. Cl. B01F 11/00

(52) U.S. Cl. 366/110

(57) ABSTRACT

An embodiment of the invention provides a small bottle shaker with a housing unit that contains a variable speed motor that is attached to a rotary drive unit. The rotary drive unit is attached to a bottle holder that has a lid with a positive retention device that keeps the lid closed when a bottle is being shaken. The bottle holder also has a bottle retention assembly that holds a bottle being shaken in position and protects it from damage.

### CROSS-REFERENCE TO RELATED APPLICATION

This application claims a priority to and claims the benefit of U.S. Provisional Application No. 61/502,858, filed on Jun. 30, 2011. U.S. Provisional Application No. 61/502,858 is hereby incorporated herein by reference.

### TECHNICAL FIELD

Embodiments of the invention relate to mixing liquids in general, and more particularly to devices for shaking small bottles of liquid mixtures to achieve a uniform composition.

### BACKGROUND

As most women are all too well aware, bottles of nail polish have a tendency to separate over time. To restore the nail polish to its intended uniformity and color, it is necessary to shake a bottle of nail polish rather vigorously and for an extended period of time. Insufficient mixing results in degraded color and polish retention. Unfortunately, shaking a bottle of nail polish to mix its content not only requires time and effort, which is irksome to the majority of women, but can be impossible to do for some because of disabilities or age.

While the foregoing problem of nail polish separation is a common inconvenience for individual women, it can become a serious problem in some circumstances. For example, nail technicians may have to mix dozens of bottles of nail polish each day to service their customers. Additionally, make-up artists in fashion shows, plays, skits, movies, and other such activities may also have to mix many bottles of nail polish every day.

In addition to nail polish separation, there are many other liquid mixtures that are packaged in small bottles and which tend to separate. For example, acrylic paints used by modelers for decoration, and enamel paints used by repairmen to touch-up automobiles and appliance finishes also come in small bottles and need to be shaken prior to use. Furthermore, some epoxies and plastics may also need to be thoroughly mixed prior to use, something that can be difficult to do by hand.

In view of the foregoing, an apparatus that shakes bottles of liquid mixtures to achieve a uniform color, consistency, and/or composition would be beneficial. Even more beneficially would be an apparatus that shakes bottles of mixtures to achieve a uniform color, consistency, and/or composition which would be easy and safe to use. Ideally, such an apparatus would protect users in case of bottle breakage and spillage. Even more beneficially, such an apparatus would also provide a protective mount for bottles being mixed.

### SUMMARY

The principles of the present invention provide for an apparatus that shakes small bottles of liquid mixtures to achieve a uniform color, consistency, and/or composition. Such an apparatus enables easy and safe shaking of small bottles and provides for a protective mount for the bottles being mixed.

Briefly stated, a small bottle shaker in accord with the principles of the present invention has a housing unit that contains a variable speed motor that is attached to a rotary drive unit. The rotary drive unit is attached to a bottle holder that has a lid with a positive retention device that keeps the lid closed when a bottle is being shaken. The bottle holder also has a bottle retention assembly that holds a bottle being shaken in position and protects it from damage.

In operation the variable speed motor rotates the rotary drive unit. The rotary drive unit engages the bottle holder which is mounted such that as the rotary drive unit turns, a reciprocating motion is applied to the bottle holder. A small bottle and its contents within the bottle holder is mixed by the reciprocating motion. Beneficially the bottle shaker is relatively small but has a stable and rigid frame.

### BRIEF DESCRIPTION OF THE DRAWINGS

The advantages and features of non-limiting and non-exhaustive embodiments of the present invention will become better understood with reference to the following detailed description and claims when taken in conjunction with the accompanying drawings, in which like elements are identified with like symbols, and in which:

FIG. 1 is a perspective illustration of a small bottle shaker having a bottle receiving lid that is shown in the open position;

FIG. 2 is a perspective view of the small bottle shaker of FIG. 1 with its bottle receiving lid closed; and

FIG. 3 is a perspective view that illustrates the small bottle shaker's bottle receiving chamber in more detail.

### DETAILED DESCRIPTION OF PREFERRED EMBODIMENTS

The presently disclosed subject matter now will be described more fully hereinafter with reference to the accompanying drawings in which one embodiment is shown. However, it should be understood that this invention may take many different forms and thus should not be construed as being limited to the embodiment set forth herein. In the figures like numbers refer to like elements throughout.

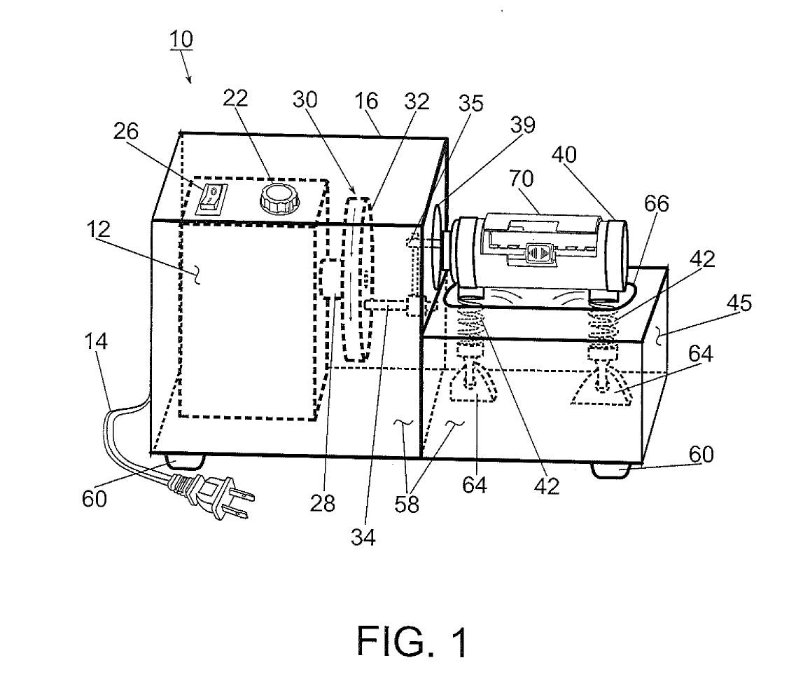

FIG. 1 illustrates a small bottle shaker 10 that is accord with the principles of the present invention. The small bottle shaker 10 which includes a variable speed electric motor 12 that can either be battery powered or AC powered via a power cord 14 (as shown). The variable speed electric motor 12 is beneficially contained in a motor housing 16 that forms part of a frame 58. An On-Off switch 26 turns the variable speed electric motor 12 on and off, while a speed control 22 varies that motor's rotational speed (and as described subsequently, the bottle shaking rate).

The variable speed electric motor 12 includes a rotating armature 28 that attaches to a rotary drive unit 30. The rotary drive unit 30 includes a round disk 32 and a connecting “L” shaped rod 34. The “L” shaped rod attaches to the shaft 35 of an elongated bottle holder 40. The shaft 35 passes through an opening 39 in the motor housing 16.

The bottle holder 40 is situated above a mount housing 45. Together, the mount housing 45 and the motor housing 16 form the frame 58. Rubber feet 60 are attached to the frame 58 to provide a gripping surface. Inside the mount housing 45 are at least two spring mounts 64. Above the spring mounts 64 is an elongated opening 66 in the top mount housing 45.

The elongated bottle holder 40 attaches to the spring mounts 64 by at least two springs 42. Those springs 42 and the attachment assembly to the rotary drive unit 30 retain the bottle holder 40 in a manner such that the bottle holder 40 remains disposed above the mount housing 45, but in a manner that the bottle holder 40 can shake on the springs 42.

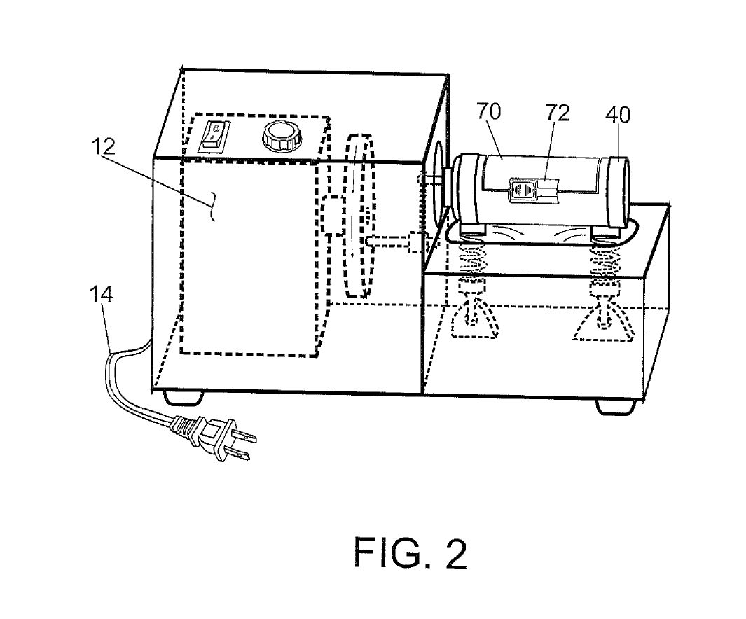

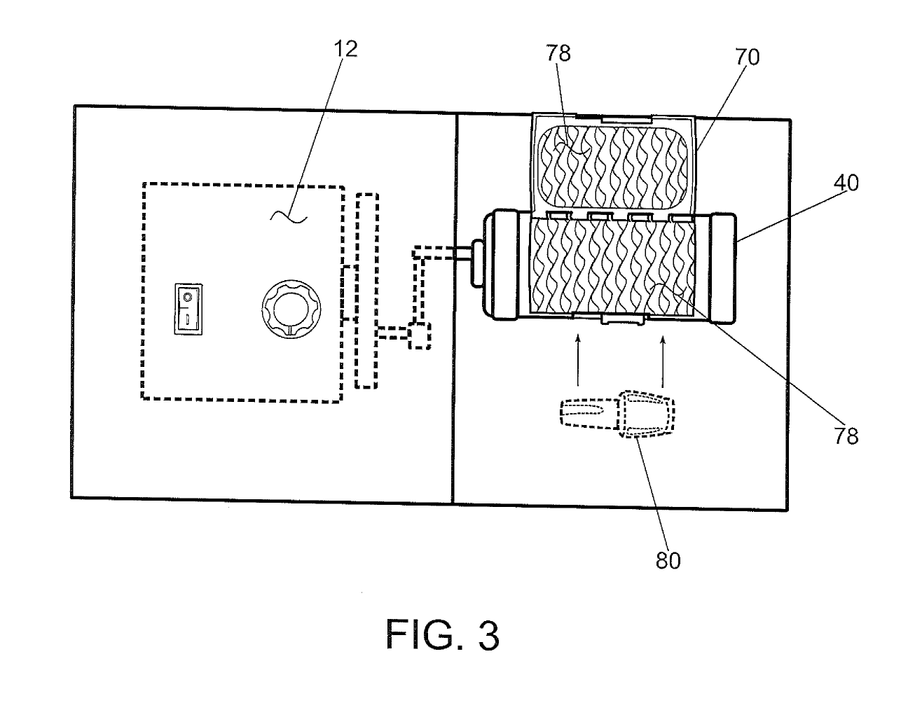

Referring now to FIGS. 1, 2, and 3, the bottle holder 40 includes a pivotal lid 70. FIGS. 1 and 3 show the pivotal lid 70 when it is open to receive a bottle 80 (see FIG. 3), while FIG. 2 shows the pivotal lid 70 closed and locked by a locking mechanism 72. Thus to open the pivotal lid 70 the locking mechanism 72 is unlocked, while to seal the pivotal lid 70 closed the locking mechanism 72 is latched closed. The locking mechanism 72 includes a detent, spring, slide, or other mechanism to positively close so as to resist opening by vibration.

Referring now primarily to FIG. 3, the pivotal lid 70 and the interior of the bottle holder 40 are both lined with a relatively rigid, but still compressible, foam liner 78 that is beneficially shaped something like an egg container: a plurality of protruding members and indentations. When a small bottle 80 (a nail polish bottle, an acrylic paint bottle, a container holding epoxy that must be mixed, or any other small bottle having ingredients that should be mixed) is placed inside the bottle holder 40 that small bottle 80 rests on the foam liner 78. When the pivotal lid 70 is closed (and latched), the foam liner 78 compresses against the small bottle 80 to form a pocket. This arrangement (which includes the lid 70, liner 78, and bottle holder 40, or which is included with the lid 70, liner 78, and bottle holder 40) allows various shaped small bottles to be retained inside the bottle holder 40.

In operation, the pivotal lid 70 is opened and a small bottle 80 that is to be mixed is then placed inside the bottle holder 40 and the pivotal lid 70 is closed and latched. As described above, this forms a pocket that holds the small bottle 80 in place. The power cord 14 is plugged into an AC outlet (or batteries are installed) and the On-Off switch 26 is turned on. This causes the variable speed electric motor 12 to turn. The speed of the variable speed electric motor 12 can be adjusted via the speed control 22. Rotation of the armature 28 rotates the round disk 32 which turns the connecting “L” shaped rod 34. Since the “L” shaped rod 34 is offset from the center of the round disk 32 the connecting “L” shaped rod 34 causes the shaft 35 to move in an offset rotational loop. This causes the front of the bottle holder 40 to begin moving. Since the bottle holder 40 is mounted on springs 42 this causes the springs 42 to interact with the moving bottle holder 40 to induce a shaking motion which shakes the ingredients in the small bottle 80.

Therefore, it is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will

recognize numerous modifications and adaptations of the illustrated embodiments that remain within the principles of the present invention. Therefore, the present invention is to be limited only by the appended claims.

What is claimed is:

1. A bottle shaker, comprising:
a frame;
an electric motor having an armature and attached to said frame;
a bottle holder with a lid and a locking mechanism, said bottle holder attached to said frame such that said bottle holder can shake;
wherein said bottle holder further includes means for retaining a bottle in said bottle holder so as to prevent damage to the bottle; and
a rotary assembly coupling said armature to said bottle holder so as to impart a shaking motion to said bottle holder when said electric motor runs.

2. The bottle shaker of claim 1, wherein the retaining means comprises a foam liner.

3. The bottle shaker of claim 2, wherein the foam liner comprises a plurality of protruding members and a plurality of indentations.

4. The bottle shaker of claim 1, wherein the retaining means is lined on an interior of the bottle holder and on the lid.

5. The bottle shaker of claim 1, wherein the retaining means compresses against the bottle to form a pocket if the lid is latched to the bottle holder.

6. The bottle shaker of claim 1, further comprising a plurality of springs coupled to the bottle holder so that the bottle holder can shake on the springs.

7. The bottle shaker of claim 1, further comprising a plurality of spring mounts coupled to the frame, wherein a spring mount of the plurality of spring mounts is coupled to a corresponding spring of the plurality of springs.

8. The bottle shaker of claim 1, further comprising a speed control coupled to the frame, the speed control permitting an adjustment of a variable speed of the electric motor.

9. A bottle shaker, comprising:
a frame;
an electric motor coupled to the frame; and
a bottle holder coupled to the electric motor, wherein the electric motor is configured to induce a shaking motion by the bottle holder.

10. The bottle shaker of claim 9, wherein the bottle holder comprises a lid and a locking mechanism and wherein the bottle holder is configured to receive a bottle.

11. The bottle shaker of claim 10, wherein the bottle holder and the lid include an arrangement configured to retain the bottle inside the bottle holder.

12. The bottle shaker of claim 10, wherein the bottle holder and the lid include an arrangement configured to retain the bottle inside the bottle holder, said arrangement comprising a foam liner.

13. The bottle shaker of claim 12, wherein the foam liner comprises a plurality of protruding members and a plurality of indentations.

14. The bottle shaker of claim 11, wherein the arrangement is lined on an interior of the bottle holder and on the lid.

15. The bottle shaker of claim 11, wherein the arrangement compresses against the bottle to form a pocket if the lid is latched to the bottle holder.

16. The bottle shaker of claim 9, further comprising a plurality of springs coupled to the bottle holder so that the bottle holder can shake on the springs.

17. The bottle shaker of claim 16, further comprising a plurality of spring mounts coupled to the frame, wherein a spring mount of the plurality of spring mounts is coupled to a corresponding spring of the plurality of springs.

18. The bottle shaker of claim 9, further comprising a speed control coupled to the frame, the speed control permitting an adjustment of a variable speed of the electric motor.

19. A method of assembling a bottle shaker, the method comprising:
providing a frame;
coupling an electric motor to the frame; and
coupling a bottle holder to the electric motor, wherein the electric motor is configured to induce a shaking motion by the bottle holder.

20. The method of claim 19, further comprising:
coupling a plurality of springs to the bottle holder so that the bottle holder can shake on the springs; and
coupling a plurality of spring mounts to the frame, wherein a spring mount of the plurality of spring mounts is coupled to a corresponding spring of the plurality of springs.
